(19) United States
(12) Patent Application Publication
(10) Pub. No.: US 2012/0204612 A1
(43) Pub. Date: Aug. 16, 2012

(54) METHOD AND APPARATUS FOR INDEPENDENT ACCESS TO A LOCKED FACILITY

(76) Inventor: Adam Wade Carson, Falmouth, KY (US)

(21) Appl. No.: 13/396,976

(22) Filed: Feb. 15, 2012

Related U.S. Application Data
(60) Provisional application No. 61/443,324, filed on Feb. 16, 2011.

(51) Int. Cl. E05B 17/22; B23P 11/00

(52) U.S. Cl. 70/466; 29/428

(57) ABSTRACT

An apparatus for allowing separate and independent access to a locked facility by multiple users is provided. The apparatus comprises at least three parts that can be joined together to provide independent access through independent locks that lock adjacent parts of the apparatus together. The apparatus provides stability and separation between the locks when the apparatus is locked or unlocked so that the locks are easily identifiable and do not get lost among hanging chains or cables.

### CROSS REFERENCE TO RELATED APPLICATION

This application claims the benefit of co-pending U.S. Provisional Patent Application No. 61/443,324 filed Feb. 16, 2011.

### BACKGROUND OF THE INVENTION

Locking a facility is usually intended to deny access to the facility by everyone except those who have a key or other unlocking device such as, for example, a keycard, security code, combination or security token. Many times when multiple entities need to have access to the facility, the unlocking device or combination is simply copied and shared among those who need to have access to the facility.

However, in some cases separate and independent access by users is needed. For example sometimes there is a hierarchy of those who need access to a facility. In a factory a foreman can need to have access to all the storage cribs in the factory, but it can be desirable to limit access by a particular worker to those cribs that pertain to his job. To accomplish such restrictions various limited access methods have been developed. For example, a keying system employing a hierarchy of keys can be used wherein the foreman has a master key that will work in any lock while individual workers have keys that will only work in the locks to which they need access. Such a system requires a sophisticated and expensive lock. Further, if the cribs are frequently changed or personnel needing access to particular cribs are frequently changed, the keying for those locks can become cumbersome and prohibitively expensive because of the constantly changing key distribution and re-keying that can become necessary to ensure a needed level of security.

Many other situations presenting similar lock control challenges can easily be envisioned. These extend across a wide variety of situations with typical examples such as a delivery person needing limited access to drop off deliveries, through apartment dwellers and landlords in apartment buildings, to providing access to critical control systems and their sub-controls. All of these can be handled using locking systems such as the key hierarchy discussed above. However, the problems with security keying and access can become very difficult.

In many cases separate and independent access to facilities is fundamental to effective operations. However, many of the systems currently used need to be improved. For many applications, particularly in the industrial world, simple locking techniques that are visually effective, easy for the user to interpret, orderly, identifiable, not subject to interpretive challenges, highly cost effective, easy to change and control, and that allow separate independent designated user access are needed.

### BRIEF DESCRIPTION OF THE INVENTION

An apparatus for allowing separate and independent access to a locked facility by multiple users is provided. The apparatus has an access plate permanently attachable to an access part, and the access plate has a lockable tab.

A structure plate permanently attachable to a structure adjacent the access part is also provided. The fixed structure plate has a lockable tab and an alignment slot and housing.

In addition a connector plate having lockable tabs and an alignment tab for aligning the connector plate with the structure plate by inserting the alignment tab in the alignment slot and housing is provided.

In use the connector plate is positioned between the access plate and the structure plate with the alignment tab in the alignment slot and housing and the lockable tabs of each plate lockably adjacent lockable tabs of adjacent plates permitting adjacent plates to be lockably engaged by locking adjacent lockable tabs together and to be separated by unlocking adjacent lockable tabs.

In addition a method for allowing separate and independent access to a locked facility by users is provided.

The method comprises permanently mounting an access plate having a lockable tab on an access part.

The method further comprises permanently mounting a structure plate having a lockable tab and an alignment slot and housing to the structure adjacent the access part.

Further, the method includes providing a connector plate having lockable tabs and an alignment tab for aligning the connector plate with the structure plate by inserting the alignment tab in the alignment slot and housing.

By positioning the connector plate between the access plate and the structure plate with the alignment tab in the alignment slot and housing and the lockable tabs of each plate lockably adjacent those of the adjacent plate near each end of the connector plate, the adjacent plates can be engaged by locking adjacent lockable tabs together using separate locks.

Each independent user can be provided with a key to open one of the locks and separate adjacent plates to access the facility.

### BRIEF DESCRIPTION OF THE DRAWINGS

FIG. 1 is daisy chained padlocks;

FIG. 2 is a dual lock apparatus;

FIG. 3 is apparatus on a crib;

FIG. 4 is connector plates and a structure plate; and

FIG. 5 is apparatus used on access parts that swing out of a structure plane.

### DETAILED DESCRIPTION OF THE INVENTION

Securing facilities is necessary in nearly any environment. The basic need when securing something is to limit access to the secured facility, whether it is something, for example, as simple as a ladder chained to an immovable object or as complicated as a large commercial or government facility.

Unless the facility is going to be monitored or guarded constantly, the securitization is usually accomplished by employing some kind of locking system. Even when constant monitoring is practiced, locks are nearly always used as additional security to limit access to the facility.

In what follows the word “key” will be taken to mean and apply to all the various means used to open a lock short of breaking it or defeating it in some other way. For example, a physical key such as a car key, a combination, a code, a security token, or other means might be used without defeating the purpose of the lock.

Even for the simplest facility, it is often necessary to allow multiple users access to the facility. This has resulted in development of many different methods for allowing access that range from the very simple to the very complicated.

One complicated case arises when there are multiple facilities being secured with multiple locks and multiple users, but some of the users must be restricted in their access to certain facilities. To overcome this situation elaborate keying systems have been developed employing master keys and a variety of sub-keys where each subset of users has a key that will open only certain locks but not others, but the master key will open any of the locks. Such a system requires sophistication in lock design and in key making and requires constant monitoring to make sure only the intended personnel have access to each lock. Further, new keys must be created every time there is a change in access needs.

An alternative to multiple keying is multiple locking. To do this a chain of locks linked together can be used to provide individual access to a secured facility. Each lock has its own key, and the locks can be linked, sometimes termed daisy chained, together so that opening any one lock breaks the chain of locks and permits entry into the secured facility. In some cases it is desirable to use locks that permit multiple users into a secured facility but that do not allow different keys to be used in the same lock thus multiply securing a facility and allowing independent access to the area by the different users.

An example of this is propane gas tanks delivered to a group of industrial cribs located at different places in a factory. The delivery person needs to be able to get into the each crib quickly to make deliveries while the manager of the cribs needs independent access to each crib by different people whose access is limited to a particular crib.

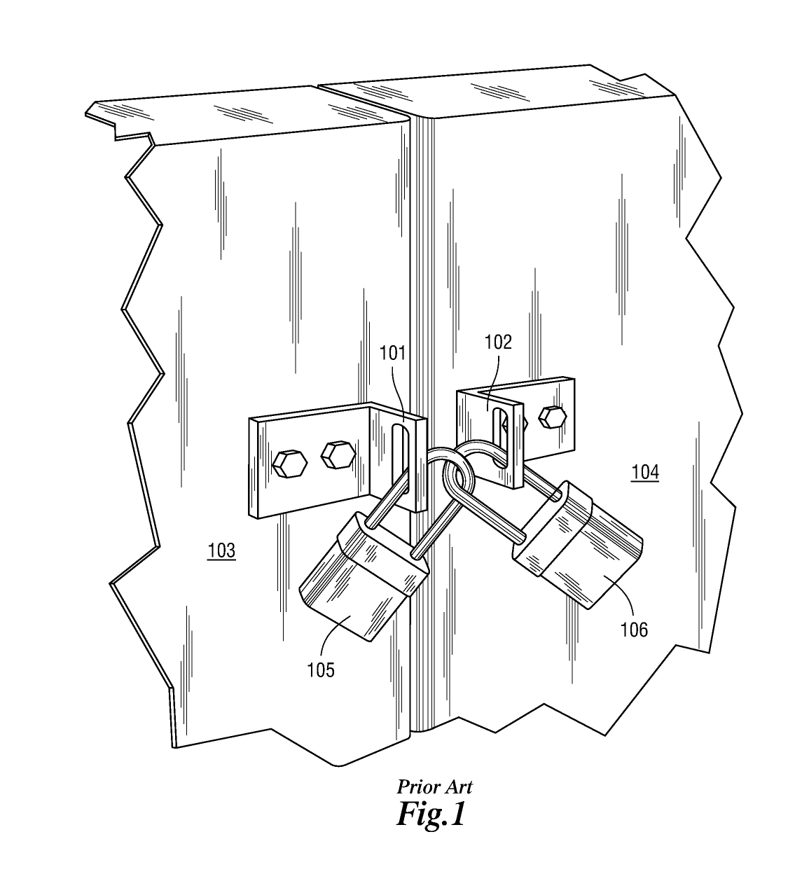

Often it is customary to secure such cribs in an industrial environment using padlocks. FIG. 1 shows such a system employing padlocks. In FIG. 1 two lockable tabs 101, 102 are mounted on a structure 103, in this case a door frame, and an access part 104, in this case a door, and are locked together using two padlocks 105, 106 that are interlinked together like links in a chain. If either of the padlocks 105, or 106 is opened the access part 104, can be opened. Of course, such linking can also be accomplished by interlinking flexible elements such as actual chains or cables and then padlocking the ends of each linked element together. As mentioned above, interlinking locking mechanisms in this way is often called daisy chaining.

While these arrangements are effective at granting access to individual people having different keys, they have several disadvantages, and they are neither functionally nor aesthetically appealing. One disadvantage is that it is difficult to hold access parts, for example a door, tightly closed when such chaining is practiced. In addition, the chains or other flexible elements tend to hang down causing difficulty identifying which lock one is accessing when needing to open a particular lock. Sometimes it is even difficult to find the locks.

Further, linking padlocks or chains is not visually appealing. In field trials daisy chaining has proven unacceptable to users, particularly, where visual appeal is important and in commercial situations where ease of access is important.

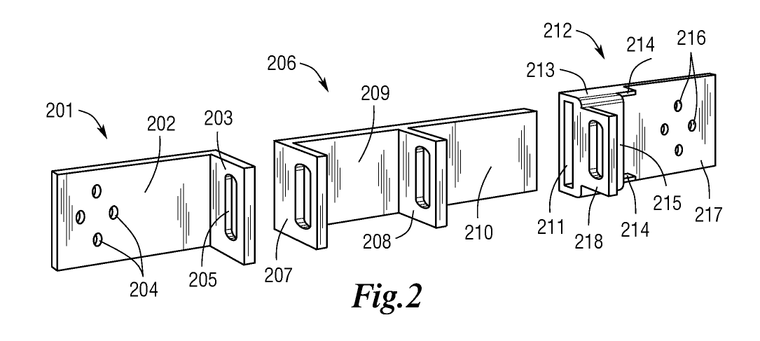

The double lock apparatus in FIG. 2 overcomes the above limitations. The apparatus shown in FIG. 2 is designed for securing an access part. An access part can be anything that is being secured by a lock such as a door to a facility that is to be locked or an item that is secured to another object such as a saw, ladder, or other item that is locked to an immovable structure, for example, as one often finds on a construction site.

The double lock apparatus of FIG. 2 is comprised of three pieces designed to fit together allowing individual locks to be separated and be easily identifiable. When it is used there are no loose cables or chains hanging down, and it is possible to address each lock without other locks, chains or cables getting in the way because the locks used are separated and easy to access and identify.

An access plate 201 is shown which can be permanently attached to the access part of the facility being secured. As shown in the drawing, the access plate 201 is designed to be attached to a door. In the discussion of FIG. 2 a door will be considered to be the access part, but the access part could be any openable or removable item that can be locked and secured. The access plate can be variously shaped to be permanently attachable to access parts when different access parts are to be secured. The access plate could even be a chain or a cable around or through an access part such as a ladder.

As shown, the access plate 201 is “L” shaped and is provided with holes 204 in the mounting side 202 for permanently mounting the plate 201 on an access part, in this case a door. The other side 203 protrudes from the plane of the door to form a lockable tab 203 for lockably securing the access plate 201 to a connector plate 206.

The connector plate 206 comprises a lockable tab 207 which is positioned at an angle to the base 209 of the connector plate 206 such that it is lockably adjacent the lockable tab 203 of the access plate 201 when the door is closed. That is, the two tabs 203 and 207 are close enough to be locked together, in this case, with a padlock when the door is closed. In FIG. 2 the tab 207 is shown perpendicular to the base of the connector plate 209, but it can be disposed at any angle necessary to lockably engage the access plate 201.

Similarly, the lockable tab 205 of the access plate can be disposed at any angle necessary so that the lockable tabs 205 and 207 are lockably adjacent each other.

The connector plate 206 extends from the locking tab 207 to another locking tab 208 which is mounted substantially perpendicular to the base of the connector plate 209. Coplanar with the base of the connector plate 209 and extending out to form the end of the connector plate 206 is an alignment tab 210. The alignment tab 210 can vary in thickness from the base 209 of the connector plate 206, but the alignment tab 210 is in a substantially parallel plane with the base 209 of the connector plate 206.

The connector tab 210 is designed to fit into an alignment slot 211 in a structure plate 212 which can be permanently attached to the structure adjacent the door, not shown in FIG. 2.

The alignment slot 211 is surrounded by an alignment slot housing 213. The housing 213 stabilizes the alignment tab 210 when it is inserted in the alignment slot 211 holding the connector plate 206 in collinear alignment with the structure plate 212. The housing can comprise guide rails 214 which can extend out beyond the alignment slot housing top 215. The alignment slot housing top 215 holds the alignment tab in a parallel plane relationship to the plane of the structure plate 212 and the guide rails 214 comprise the sides of the slot 211. The guide rails 214 in extension serve to further hold the inserted alignment tab 210 in position.

The alignment tab 210 and the alignment housing 213 provide rigidity of structure when assembled keeping the apparatus in orderly correspondence, each plate 201, 206, 212 with the other plates 201, 206, 212.

Extending perpendicularly from the top of the alignment slot housing 215 is a lockable tab 218. The tab 218 is positioned to be lockably adjacent the lockable tab 208 when the alignment tab 210 of the connector plate 206 is inserted into the alignment slot 211. In this position the tabs 208 and 218 can be locked together with a padlock.

In similar fashion when the door is closed so that the lockable tab formed by the side 203 comprising a part of the access plate 201 and the lockable tab 207 of the connector plate 206 are lockably adjacent each other, they can be locked together with a padlock.

When secured in this way, the access part can be opened by opening either padlock.

If the padlock securing the access plate 201 to the connector plate 206 is unlocked and removed, the door can swing freely open, and the connector plate 206 will remain locked to the structure plate 212.

If the padlock securing the connector plate 206 to the structure plate 212 is unlocked and removed, the connector plate 206 can be separated from the structure plate 212 allowing the door to be opened, and the access plate 201 will remain locked to the connector plate 206.

In this way individual users can have independent access to the secured facility based on the particular lock to which they have a key, while other users can have access based on their particular lock and key.

The apparatus of FIG. 2 is often made of galvanized steel but can be made of any material that is sufficiently robust to withstand the rigors of use in any particular application. Common examples are stainless steel, brass, bronze, or titanium with lighter materials such as plastics usable where the conditions of use and security requirements are less rigorous.

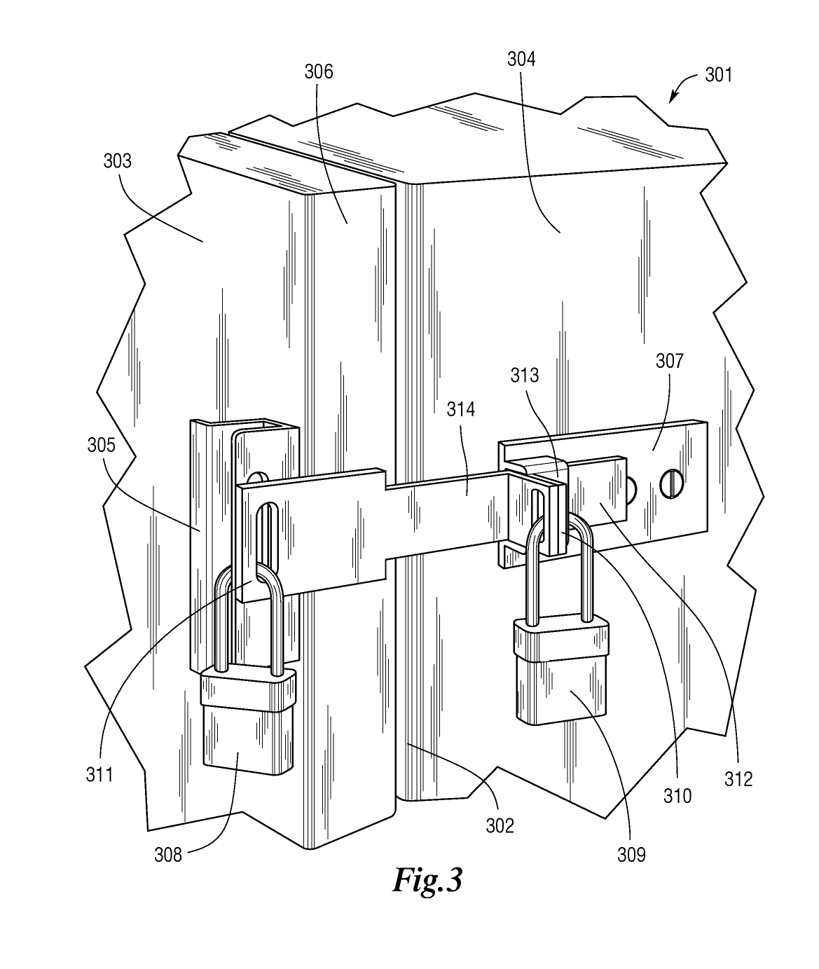

FIG. 3 shows a lockable apparatus similar to the apparatus of FIG. 2 installed on a gas cylinder storage crib 301. In FIG. 3 the gas storage crib 301 has a hinged swing out door 306 having a door front 303, and the door 306 closes against the corner of the crib 302 such that the door edge is substantially even with the side of the crib 304. The access plate 305 is mounted on the front 303 of the door 306 and the structure plate 307 is mounted on the side of the crib 301. The apparatus is locked with padlocks 308, 309 through the adjacent lockable tab set 310 and through adjacent lockable tab set 311.

As can be seen, unlocking either padlock 308 or 309 will allow the door 306 to be swung open. The alignment tab 312 when inserted in the alignment housing 313 keeps the connector plate 314 in alignment so that the lockable tab sets 310, 311 are in alignment and are easy to deal with when locking or unlocking the crib 301.

In another embodiment the access plate can be modified from that shown in FIG. 2. The access plate can be shaped so that when the double lock apparatus is assembled and locked together, the fasteners mounting the access plate to the door are covered by the apparatus. For example, using the apparatus of FIG. 2, this could be accomplished by attaching the access plate on the door edge between the door edge and the structure edge with just the lockable tab exposed as it extends out from the door. This limits access to the mounting means making it difficult to defeat the apparatus by separating the access plate from the door.

Referring again to FIG. 2, mounting holes 216 are shown for mounting the structure plate 212 to the structure, which is not shown. When fasteners are used to mount the structure plate 212 which do not rise substantially above the top plane 217 of the structure plate 212 such as, for example, bolts or screws employing flat heads and countersunk below the top surface 217 of the structure plate, the alignment tab 210 can be made of sufficient length to cover the mounting holes 216 improving the security of the apparatus by preventing access to the means used for mounting the structure plate 212.

Such a situation is shown in FIG. 3 where alignment tab 312 covers the mounting means of the structure plate 307. The structure plate is constructed so that access to the mounting means can be limited by the apparatus when it is assembled and locked together.

In another embodiment the solid access plate 201 shown in FIG. 2 need not be solid at all. The access plate can be replaced by any method of securely attaching the door to the lockable tab 207 of the connector plate 206. For example, a cable or chain could be run through the door with the ends padlocked together with the connector plate locking tab 207. In such cases the replacement access plate itself could be removed from the door when the lock is open. This is useful for cases of use where it is undesirable to have an access plate permanently attached to the door.

In any case the structure of the invention keeps the locks separate, easily identifiable as to function and so long as separate locks are used accessible by independent users as desired.

An alternative embodiment uses the double lock apparatus to attach an item to a secured structure. For example an item of equipment such as a power saw or a ladder could be secured to an immovable object on a construction site with independent locks available for service personnel and for select workers. In this case either a solid, a flexible or other means of attachment could be used to replace the access plate.

Previous embodiments have employed padlocks to lock the plate elements together. However, in another embodiment other kinds of locks can be used to lock the plates together. For example, disc locks, various cylinder locks, bolt locks and others can be used to lock the lockable tabs together.

Also, the apparatus can be modified in various ways to allow the plates to be locked together. For example, referring to FIG. 2, the connector plate 206 can be locked to the structure plate 212 and possibly even to the underlying structure. To do this a hole can be placed through the extended alignment tab 210, through the underlying structure plate 212 and into the underlying structure, if appropriate, so that the holes match when the alignment tab is inserted in the alignment slot and housing. A bolt type lock or other single sided access lock can then be placed through the holes to lock them together.

In similar fashion when the access plate extends under the connector plate, holes can be placed through the connector plate, through the access plate and, again if appropriate, into the access part with a similar lock placed through the holes to lock them together.

This arrangement is particularly useful when the apparatus is mounted on an access part or structure comprising limited thickness parts such as metal sheet or metal frames such as “L” channel, “U” channel, or box channel.

Modifying the apparatus in this way will remove the need for lockable tabs and can be an effective way of lowering the profile the apparatus.

In another embodiment the plates can be mounted to the facility being secured by constructing the facility and the apparatus in such a way that one or more of the plates can be removably mounted to its mounting point or points on the facility by using a lock between the plate and the underlying facility to attach the plate.

From a different aspect the apparatus of FIG. 2 can be turned around or reversed so that the access plate 201 is attached to the structure and the structure plate 212 is attached to the access part. Use of this arrangement is dependent on the particular facility on which the apparatus is installed.

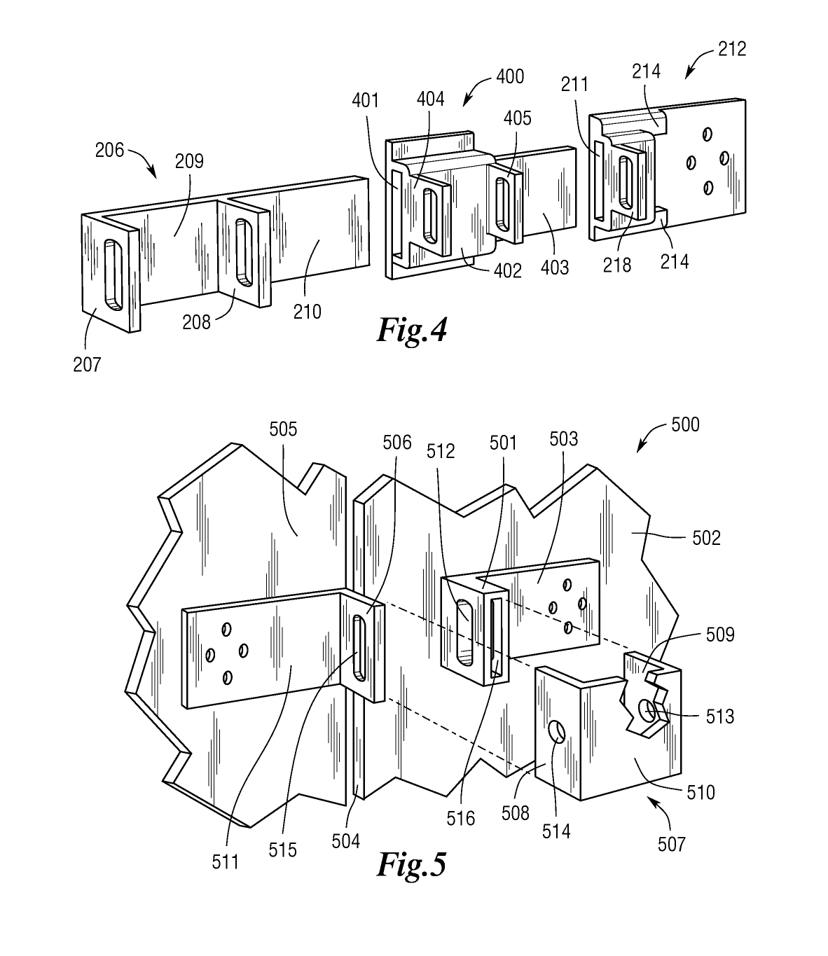

Sometimes it is desirable to have more than two lockable sets of tabs that can be locked together. For example, when there are three independent users, each requiring independent access to a lockable facility, a connector extension plate 400 as shown in FIG. 4 can be used to expand independent access capability. The connector extension plate 400 is comprised of an alignment slot 401, an alignment slot housing 402, an alignment tab 403, and two lockable tabs 404 and 405.

In use the extension plate 400 is inserted between the connector plate 206 and the structure plate 212 as shown in FIG. 4 by placing the alignment tab 403 in the alignment slot 211. On the opposite end of the connector plate the alignment tab 210 is placed in the alignment slot 401 of the extension plate 400. So doing maintains the alignment and solidity of the apparatus keeping the parts together and well aligned until they are intentionally unlocked and separated.

To enhance this alignment the alignment housing 402 and its corresponding alignment tab, in this case, 210 can be made as long as necessary for the application.

Also, it should be noted that in the embodiment shown no guide rails 214 are used with the extension plate since when using an extension plate 400 it is usually desirable to move the lockable tabs 405 and 218 as close together as possible to enhance the solidity of the aligned and assembled apparatus. However, if it is necessary for the particular application, guide rails can be added to the extension plate 400 though it is usually easier to just lengthen the alignment tab housing 402 if additional support is needed.

Any number of extension plates 400 can be added to the apparatus according to the number of independent users needing access to the secured facility. Each addition of an extension plate 400 adds one additional opportunity to lock the apparatus and facility independently.

When mounting the apparatus permanently to the facility being secured, the length of the apparatus, as used, must be taken into account if it is desirable to ensure that the access part will be tightly closed. Adding additional connector extension plates 400 will lengthen the apparatus. Therefore, it is best to assemble the apparatus as it will be used and carefully position the apparatus when installing.

The apparatus improves access to a locked facility by multiple independent and separate users when such access needs to be controlled. As described above, it is useful when one encounters a situation where an access part is used adjacent a corner or when an access part closes on a corner.

In another embodiment the above described apparatus is also useful in situations where an access part moves in a plane parallel and close to that of a structure such as on a sliding door that moves substantially in a plane parallel to the structure as in or on a wall. In these kinds of situations the apparatus can be mounted with the structure plate attached to the structure and the access plate attached to the access part. The only adjustment that might have to be made is to adjust lockable tabs, particularly between the access plate and the connector plate, to ensure that they are in alignment for locking.

However, in another embodiment the apparatus can be adapted to use when the access part must swing out from a planar surface. Examples of this are a hinged door in a wall, a hinged gate in a fence, or some other planar situation where the access part needs to depart the plane of its structure to be opened or separated therefrom.

Referring to FIG. 5 in this embodiment the apparatus 500 is constructed so that the alignment housing 501 is perpendicular to the plane of the structure 502. The structure plate 503 is mounted back from the edge of the door frame 504 of the structure 502.

On the access part, in this case the door 505, the access plate 511 is mounted close to the edge of the door 505 with lockable tab 506 perpendicular to the plane of the door.

The connector plate 507 comprises a lockable tab 508 and an alignment tab 509. Both tabs 507 and 509 are perpendicular to the base of the connector plate 510.

In use the structure plate 503 is positioned so that when the alignment tab 509 is inserted in the alignment housing 501 the lockable tab 508 of the connector plate is lockably adjacent the lockable tab 506 of the access plate 511.

In this embodiment a hole 512 is disposed through the alignment housing 501. Another hole 513 is disposed in the alignment tab 509 such that when the alignment tab 509 is inserted in the alignment housing 501 through the alignment slot 516, the holes 512, 513 align. This allows a padlock to be placed through the holes 512, 513 to lock the structure plate 503 and the connector plate 507 together.

Similarly, when the access part 505 is closed, the lockable tabs 506 and 508 are lockably adjacent and a second padlock can be passed through their holes 514, 515 to lock the connector plate 507 and the access plate 511 together.

As shown in FIG. 5 and as discussed above, with the apparatus 500 installed, assembled, and locked together with padlocks, unlocking the padlock attached to the access plate will allow the door to swing either in or out with respect to the structure 502. However, unlocking the padlock attached to the structure plate, and not the padlock attached to the access plate, will only allow the door to be swung in one direction because the connector plate 507 still attached to the access plate 511 will preclude the door 505 swinging in the other direction. In some applications this gives added utility to the apparatus 500. However, should it be desirable to swing the door 505 in both directions when just the structure plate side is unlocked, a padlock with a shackle large enough to allow the connector plate 507 to be swung out of the way can be used to allow the door 505 to swing in either direction.

For singly hinged doors that swing only in one direction or the other, the direction of swing can be accommodated, if necessary, by reversing the installation of the apparatus 500 so that the access plate 511 is mounted on the structure 502 and the structure plate 503 is mounted on the door 505. In this way the direction of swing can be reversed.

As before, the use of the apparatus 500 eliminates the need to daisy chain locks, chains, cables and the like and gives increased stability to the locking situation because of use of the alignment tab 509 and alignment housing 501. Further, the locks are kept separate and can be easily identified with respect function, and the door 505 can be easily secured without having to sort out the parts and functions of a daisy chain.

This invention has been explained with respect to the details, arrangements of components and certain specific embodiments shown in the accompanying drawings. These embodiments can be modified by those skilled in the art without departing from the spirit and scope of this invention. The appended claims are intended to be interpreted to cover apparatus and methods that do not depart from the spirit and scope of this invention.

I claim:

1. An apparatus for allowing separate and independent access to a locked facility by users comprising:
an access plate permanently attachable to an access part, the access plate comprising a lockable tab;
a structure plate permanently attachable to a structure adjacent the access part, the structure plate further comprising a lockable tab and an alignment slot and housing; and
a connector plate having lockable tabs and an alignment tab for aligning the connector plate with the structure plate by inserting the alignment tab in the alignment slot and housing,
where the connector plate is positioned between the access plate and the structure plate with the alignment tab in the alignment slot and housing and the lockable tabs of each plate lockably adjacent lockable tabs of adjacent plates permitting adjacent plates to be lockably engaged by locking adjacent lockable tabs together and to be separated by unlocking adjacent lockable tabs.

2. The apparatus of claim 1 where extension connector plates having an alignment slot, an alignment housing, an alignment tab, and at least two lockable tabs are added to the apparatus to provide independent access by a desired number of users.

3. The apparatus of claim 1 wherein the alignment tab extends through the alignment slot and housing covering mounting hardware that attaches the structure plate to the structure.

4. The apparatus of claim 1 where the access plate is removably attached to the access part.

5. The apparatus of claim 1 where the apparatus is mounted with access to apparatus mounts limited by the apparatus when the apparatus is assembled and locked.

6. The apparatus of claim 1 where the apparatus is reversed with the access plate mounted to the structure and the structure plate mounted to the access part.

7. The apparatus of claim 1 constructed for use when the access part swings out from a planar surface.

8. The apparatus of claim 1 constructed for use when an access part closes at the corner of a facility.

9. The apparatus of claim 1 constructed for use when an access part slides in a plane parallel to a planar surface.

10. The apparatus of claim 1 wherein lockably adjacent tabs are locked together using padlocks.

11. The apparatus of claim 1 where at least one of the plates is removably attached to a mounting point using a lock.

12. The apparatus of claim 1 where the apparatus is used to lock a storage crib.

13. A method for allowing separate and independent access to a locked facility by users comprising the following:
permanently mounting an access plate having a lockable tab on an access part;
permanently mounting a structure plate having a lockable tab and an alignment slot and housing to the structure adjacent the access part;
providing a connector plate having lockable tabs and an alignment tab for aligning the connector plate with the structure plate by inserting the alignment tab in the alignment slot and housing;
positioning the connector plate between the access plate and the structure plate with the alignment tab in the alignment slot and housing and the lockable tabs of each plate lockably adjacent those of the adjacent plate near each end of the connector plate;
engaging adjacent plates by locking adjacent lockable tabs together using separate locks; and
providing each independent user with a key to open one of the locks and separate adjacent plates to access the facility.

14. The method of claim 13 further comprising using extension connector plates having alignment slots and housings, alignment tabs, and lockable tabs to provide independent users additional independent locks.

15. The method of claim 13 further comprising limiting access to mountings of the access plate and of the structure plate by covering the mountings with the plates.

16. The method of claim 13 further comprising reversing the positions of the access plate and the structure plate.

17. The method of claim 13 further comprising constructing the plates for use when an access part is mounted in a wall and swings out from the wall.

18. The method of claim 13 further comprising constructing the plates for use when an access part closes at the corner of a facility.

19. The method of claim 13 further comprising locking the adjacent lockable tabs together using padlocks.

20. The method of claim 13 wherein the locked facility is a storage crib.
